(19) United States
(12) Patent Application Publication
(10) Pub. No.: US 2009/0141191 A1
(43) Pub. Date: Jun. 4, 2009

(54) SCANNING IMAGE DISPLAY AND SCANNING IMAGE DISPLAY SYSTEM

(75) Inventors: Shigeo Nojima, Suwa-shi (JP); Tomio Ikegami, Chino-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/326,733

(22) Filed: Dec. 2, 2008

(30) Foreign Application Priority Data
Dec. 3, 2007 (JP) 2007-312643

(51) Int. Cl. H04N 9/31

(52) U.S. Cl. 348/744; 348/E09.025

(57) ABSTRACT

A scanning image display includes a plurality of light sources adapted to emit a plurality of light beams, and a scan unit adapted to scan the light beams emitted from the light sources on a projection surface, which comprises a plurality of sub-illumination areas, in a first and second direction. One of the first and second directions is a high-speed scan direction and the other is a low-speed scan direction. The sub-illumination areas are arranged in the low-speed scan direction, such that the light beams scanned in adjacent sub-illumination areas are scanned in the opposite direction.

### BACKGROUND OF THE INVENTION

The entire disclosures of Japanese Patent Application No. 2007-312643, filed Dec. 3, 2007 is expressly incorporated herein by reference.

1. Technical Field

The present invention relates to a scanning image display and a scanning image display system.

2. Related Art

In recent years, scanning image displays have been adapted so as to display an image by raster-scanning a light beam such as a laser beam on a projection surface.

In order to generate an image using the scanning image display, it is necessary to scan a light beam two-dimensionally using a scanner such as a polygon mirror or a galvanometer mirror. Although a two-dimensional method of scanning a light beam can be used where a single scanner scans in both the horizontal and vertical directions, the resulting scanner is more complicated and difficult to control. Therefore, scanning image displays are typically provided with two sets of scanners, each of which scans along one dimension using a single light beam. Thus one light beam scans in the horizontal direction and one scans in the vertical direction. In the past, it has been common to use polygon mirrors or galvanometer mirrors in each of the scanners, and a projection device using rotating polygon mirrors for both of the scanners has been proposed (see e.g., Japanese Patent Application No. JP-A-1-245780).

Incidentally, in order to achieve higher resolution of the scanning image display, it is necessary to reduce the size of the pixels on the screen or to increase the image size on the screen. Therefore, in order for reducing the pixel size, there is a need to enlarge the beam diameter on the scanner. More specifically, there is a need to increase either the effective diameter D of the scanner to increase the numerical aperture NA of the beam, or the rotation angle of θ of the scanner. Further, the relationship of N=Dθ/Kλ exists between the resolution N, the effective diameter D of the scanner, and the rotation angle θ of the scanner. Here, N denotes the resolution (the number of pixels) in the scan direction, K denotes a constant, and λ denotes the wavelength of the beam. Therefore, in order for increasing the resolution N, it is necessary to increase the product of the effective diameter D of the scanner and the rotation angle θ of the scanner in proportion thereto.

Further, in order for increasing the resolution in both a horizontal direction (the scan direction) and the vertical direction, it is necessary to increase faster scan rate of the operation speed of either the scan rates of the scanner in the horizontal direction or the scan rates scanner in the vertical direction. However, since there exists a reciprocal relationship between the scan angle and the operation speed of the scanner, it is difficult to increase both of the scan angle and the operation speed of the scanner. Further, the same relationship as the relationship between the scan angle and the operation speed of the scanner exists between the effective diameter D and the operation speed of the scanner.

Therefore, it is difficult to increase the effective diameter D and the scan angle θ of the scanner while simultaneously increasing the operation frequency or operating speed of the scanner. Therefore, it is difficult to generate a display which is capable of displaying an image of a high resolution, such as the high definition television (HDTV) class in high quality, with a set of scanners.

In order for solving this problem, there has been proposed a method of increasing the number of beams used by a set of scanners, wherein the imaging process is performed with a plurality of scan lines at a time. Another proposed method includes tiling beam scan displays with low resolution (see e.g., “Projection Optical System for a Scanned LED TV Display,” Proceedings of SPIE Vol. 4773).

The scanning image display described tiling beam scan process scans light beams emitted from two LED arrays using a polygon mirror. Each LED array has a plurality of LEDs arranged in a vertical and horizontal direction. The light beams emitted from one of the LED arrays are scanned on the right half screen and the light beams emitted from the other of the LED arrays are scanned on the left half screen.

However, in the technology described in the “Projection Optical System for a Scanned LED TV Display,” as shown in FIG. 8, the scan corresponding to a projection image on the right half of a screen 100 and the scan corresponding to a projection image on the left half of the image are executed at the same time. Thus, when illumination of the upper left end A1 of the left half illumination area A starts, the upper left end B1 of the right half illumination area B on the same scan line in the horizontal direction is also illuminated. One problem, however, is that when an object K moves rapidly in a direction indicated by the arrow, for example, the display timing of the illumination area C in the seam between the left and right images is different between the display of the left half and the display of the right half. Specifically, since there is a time difference corresponding to one horizontal scan period in displaying the illumination area C of the seam section, there are misalignment problems in the resulting display in the illumination area C, which degrades the display of the moving image.

### BRIEF SUMMARY OF THE INVENTION

In view of the problem described above, the invention has an advantage of providing a scanning image display and a scanning image display system capable of displaying high resolution images in high quality, with superior moving image display characteristics.

In order for obtaining the above advantage, the invention provides the following measures. One aspect of the invention is a scanning image display comprising a plurality of light sources capable of emitting a plurality of light beams, and a scan unit capable of scanning the light beams emitted from the light sources on a projection surface, which comprises a plurality of sub-illumination areas, in a first direction and a second direction which is substantially perpendicular to the first direction, in order to display an image on the projection surface. In the scanning image display one of the first and second direction is a high-speed scan direction in which the light beams are scanned at a higher speed, and the other of the first and second direction comprises a low-speed scan direction in which the light beams of the other of the first and second direction are scanned at a lower speed than the higher speed of the high-speed scan direction, the sub-illumination areas being arranged in the low-speed scan direction, and the low-speed scan direction of one sub-illumination area being opposite to the low-speed scan direction of an adjacent sub-illumination area.

In the scanning image display according to this aspect of the invention, the light beams emitted from the plurality of light sources are scanned in the plurality of sub-illumination areas in the first and second directions, thereby displaying the image on the projection surface.

Here, since in the related art, the low-speed scan direction is the same in the adjacent two sub-illumination areas, the timing for scanning the seam section between the adjacent two sub-illumination areas is shifted by one scan period. In contrast, in the scanning image display according to this aspect of the invention, the low-speed scan direction of the light beams scanned in one of the sub-illumination areas and the low-speed scan direction of the light beams in another of the sub-illumination areas adjacent to the one of the sub-illumination areas are opposite to each other. Thus, it becomes possible to substantially simultaneously scan the light beams in the illumination area. Therefore, because the time difference corresponding to one scan period caused in the scanning in the same direction can be prevented, a display misalignment in the seam section can be prevented. Therefore, it becomes possible to provide a scanning image display capable of displaying a high-resolution image in high quality, and superior in the moving image characteristic.

A scanning image display system according to still another aspect of the invention comprises a plurality of scanning image displays. Each scanning image comprises at least one light source adapted to emit at least one light beam, a scan unit adapted to scan the light beams emitted from the at least one light source on a projection surface, which comprises a plurality of sub-illumination areas, in a first direction and a second direction substantially perpendicular to the first direction, so as to display an image. In the scanning image display system, one the first and second direction is a high-speed scan direction in which the light beams are scanned at a higher speed, and the other of the first and second direction comprises a low-speed scan direction in which the light beams of the other of the first and second direction are scanned at a lower speed than the higher speed of the high-speed scan direction, the illumination areas being arranged in the low-speed scan direction, and the low-speed scan direction in one illumination area being opposite than the low-speed scan direction of an adjacent illumination area.

A third aspect of the invention is a scanning image display comprising a plurality of light sources capable of emitting a plurality of light beams, and a scan unit capable of scanning the light beams emitted from the light sources on a projection surface, which comprises a plurality of sub-illumination areas, in order to display an image on the projection surface. In this aspect of the invention, the scan unit comprises a first low-speed scan section capable of scanning at least one of the light beams emitted from at least one of the light sources in a low-speed scan direction, a second low-speed scan section capable of scanning the remaining of the light beams emitted from the of the light sources in a second scan direction opposite to the first scan direction, and a high-speed scan section capable of scanning the light beams emitted from the light sources in a high-speed scan direction, which is substantially perpendicular to the low-speed scan direction. In the scanning image display, the light beams are scanned at a higher speed in the high-speed scan direction than in the low-speed scan direction, and wherein the sub-illumination areas are arranged in the low-speed scan direction such that adjacent sub-illumination areas are scanned using alternating first and second low-speed scan sections, such that the light beams emitted from adjacent sub-illumination areas are scanned in opposite directions.

### BRIEF DESCRIPTION OF THE DRAWINGS

The invention will now be described with reference to the accompanying drawings, wherein like numbers reference like elements.

FIG. 1A is a perspective view illustrating a scanning television equipped with a scanning image display according to a first embodiment of the invention;

FIG. 1B is a side view illustrating the scanning television of FIG. 1A;

FIG. 2 is a plan view of the scanning image display shown in FIGS. 1A and 1B;

FIG. 3 is a plan view showing a configuration of a light source shown in FIG. 2;

FIG. 4 is a plan view showing a scan direction of light scanned by the scanning image display on a projection surface;

FIG. 5 is a diagram showing voltage waveforms applied respectively to first and second low-speed scan sections;

FIG. 6 is a plan view showing a scanning image display system according to a second embodiment of the invention;

FIG. 7 is a plan view showing a modified example of the scanning image display system according to the second embodiment of the invention; and

FIG. 8 is a plan view showing a scanning image display of the related art.

### DESCRIPTION OF EXEMPLARY EMBODIMENTS

Hereinafter, the scanning image display and the scanning image display systems according to some embodiments of the invention will be explained with reference to the accompanying drawings. It should be noted that the scale size of each member is accordingly altered so that the member is shown large enough to be recognized in the drawings below.

### First Embodiment

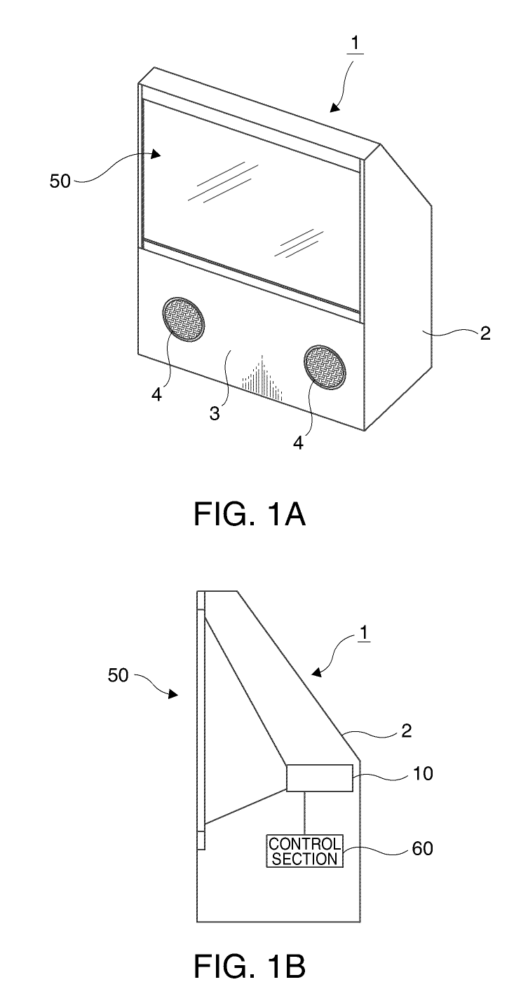

The scanning image display according to a first embodiment of the invention will be explained with reference to FIGS. 1-5.

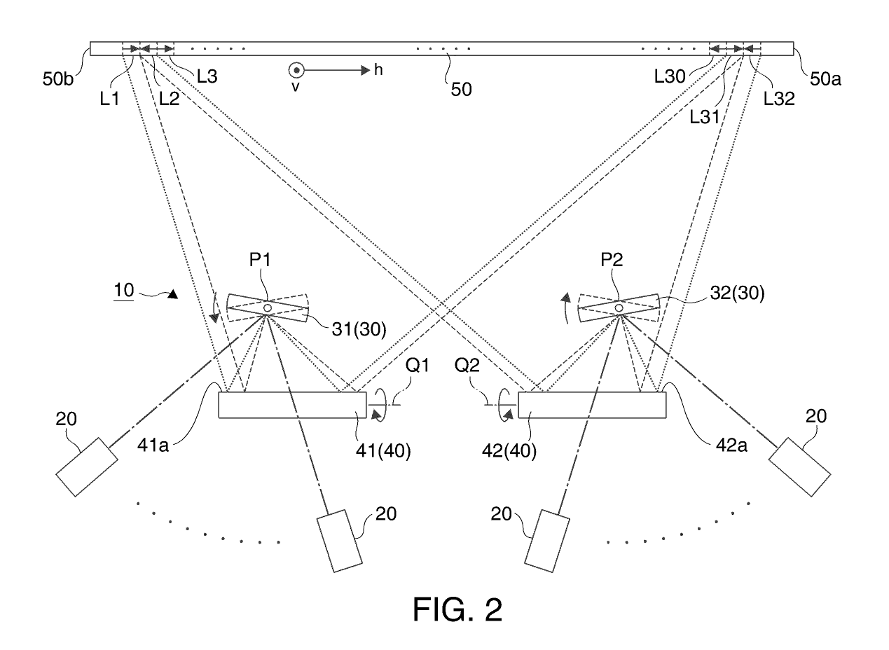

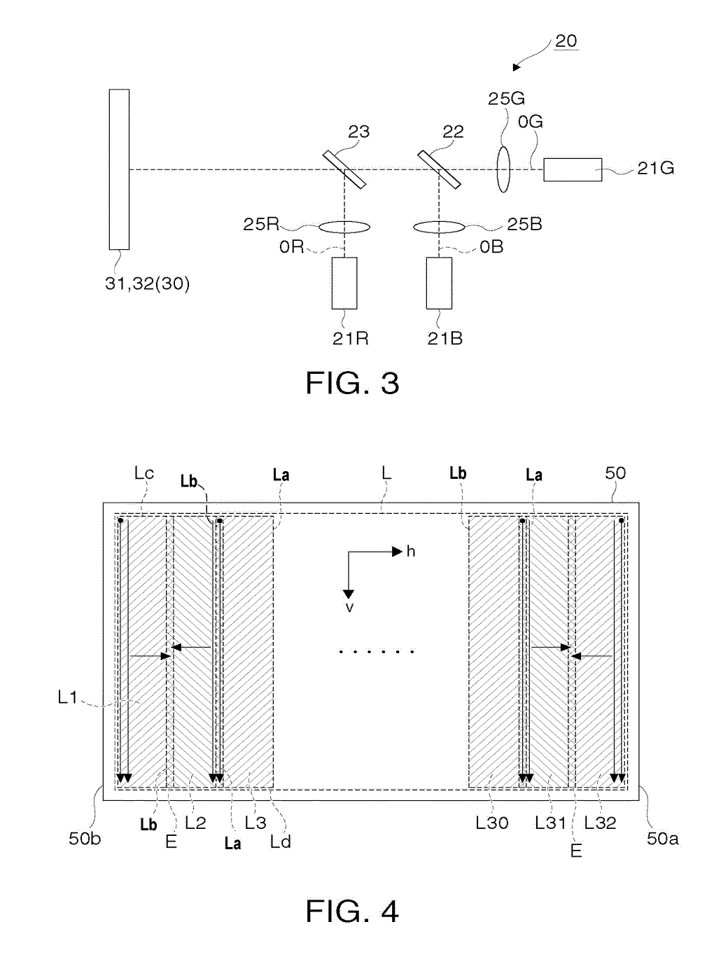

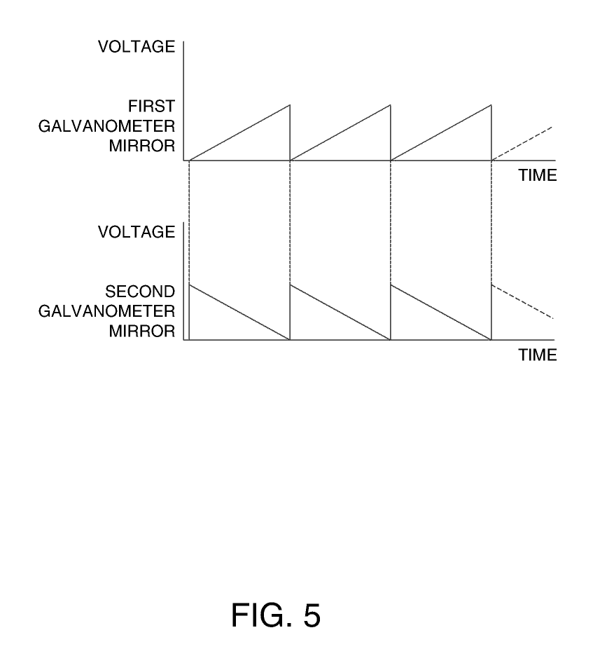

A rear-projection scanning television 1 which is illuminated from behind will be exemplified and explained as an example of a device capable of being equipped with the scanning image display of the present embodiment. FIG. 1A is a perspective view showing a schematic configuration of the scanning television, and FIG. 1B is a side view of the scanning television shown in FIG. 1A. FIG. 2 is a plan view showing the operation of a horizontal scan section and a vertical scan section. FIG. 3 is a plan view showing a configuration of a light source. FIG. 4 is a plan view showing an illumination area of light scanned by the horizontal scan section and the vertical scan section on a screen. FIG. 5 is a diagram showing voltage waveforms applied respectively to first and second horizontal scan sections.

As shown in FIGS. 1A and 1B, the scanning television 1 is provided with a housing 2, the scanning image display 10, a screen (a projection surface) 50 attached to the front of the housing 2 and on which an image is projected, and a control section 60. The housing 2 is provided with a front panel 3 below the screen 50, and right and left areas of the front panel 3 are provided with opening sections 4 for outputting sounds from speakers.

As shown in FIG. 1B, the scanning image display 10 is disposed inside the housing 2 of the scanning television 1. Further, it is arranged that an image is displayed by scanning the light emitted from the scanning image display 10 on the screen 50 in both the horizontal direction (a first direction) and the vertical direction (a second direction).

The resolution of the screen of the scanning television 1 of the present embodiment is the Hi-Vision resolution of 1920×1080, the size thereof is 55 inches, and the luminance thereof is 1300 lumens. It should be noted that each of these values is an example only and the scope and meaning of the claims below is not limited to these values.

As shown in FIG. 2, the scanning image display 10 is provided with 32 light sources 20, two horizontal scan sections 30, and two vertical scan sections 40. It should be noted that in FIG. 2, although 16 light sources 20 are provided in each of the two horizontal scan sections 30, the four light sources 20 respectively scanning sub-illumination areas L1, L2, L31, and L32 (two sub-illumination areas from each of the outermost positions) described later are only illustrative, and overlapping illumination areas E are omitted for avoiding complication of the drawing.

As shown in FIG. 3, the light source 20 specifically has a red light source 21R, a green light source 21G, a blue light source 21B, a first dichroic mirror 22, a second dichroic mirror 23, a red collimator lens 25R, a green collimator lens 25G, and a blue collimator lens 25B.

The red light source 21R emits red light modulated in accordance with image information, the green light source 21G emits green light modulated in accordance with image information, the blue light source 21B emits blue light modulated in accordance with image information. The red light source 21R and the blue light source 21B are laser diodes, and the green light source 21G is a wavelength converting laser diode. As the green light source 21G, for example, a configuration of converting infrared light into light with a predetermined wavelength by a wavelength conversion element is adopted. Further, the wavelength of the red light emitted from the red light source 21R is 640 nm, the wavelength of the green light emitted from the green light source 21G is 532 nm, and the wavelength of the blue light emitted from the blue light source 21B is 445 nm.

It should be noted that the light modulation used in each of the light sources 21R, 21G, and 21B is direct modulation, and the modulation rate is about 10 MHz. Further, the optical output per unit of each of the red light source 21R, the green light source 21G, and the blue light source 21B is 60 mW in the red light, 40 mW in the green light, and 30 mW in the blue light, respectively. Further, the beam quality M² (an index representing beam quality, a ratio obtained by dividing the spread angle of an actual beam by the spread angle of an ideal diffraction-limited beam) is equal to or smaller than 1.5.

Further, as shown in FIG. 3, the red light source 21R and the blue light source 21B are disposed so that the red light and the blue light are emitted to have the center axes OR, OB forming an angle of 90° with the center axis OG of the light emitted from the green light source 21G.

The first dichroic mirror 22 is disposed at a position where the green light emitted from the green light source 21G and the blue light emitted from the blue light source 21B intersect each other. Further, the first dichroic mirror 22 reflects the blue light so as to have the same light path as the center axis OG of the green light, and transmits the green light.

The second dichroic mirror 23 is disposed at a position where the green light emitted from the green light source 21G and the red light emitted from the red light source 21R intersect each other. Further, the second dichroic mirror 23 reflects the red light so as to have the same light path as the center axis OG of the green light, and transmits the green light and the blue light.

The red collimator lens 25R is disposed on the light path between the red light source 21R and the second dichroic mirror 23, and collects the light emitted from the red light source 21R and causes it to have a predetermined beam diameter. The green collimator lens 25G is disposed on the light path between the green light source 21G and the first dichroic mirror 22, and collects the light emitted from the green light source 21G and causes it to have a predetermined beam diameter. The blue collimator lens 25B is disposed on the light path between the blue light source 21B and the first dichroic mirror 22, and collects the light emitted from the blue light source 21B and causes it to have a predetermined beam diameter.

Specifically, the collimator lenses 25R, 25G, and 25B respectively collect the red light, the green light, and the blue light so as to have the beam radius of 0.96 mm at the beam waist position. Further, the screen 50 and the scanning image display 10 are disposed at a distance so that the beam waist is positioned on the screen 50 and the size of the image displayed on the screen 50 becomes 55 inches. In the case in which the size of the image displayed on the screen 50 is 55 inches, the size of each pixel is 0.63 mm.

It should be noted that the beam radius is not limited to this value, but can appropriately be changed in accordance with the size of the screen 50 or the number of pixels. Further, unlike with liquid crystal displays, plasma displays, and so on, the scanning television 1 does not have fixed pixels, and it becomes possible to change the number of pixels by varying the modulation rate of each of the light sources 21R, 21G, and 21B or the beam radius determined by each of the collimator lenses 25R, 25G, and 25B.

In the present embodiment, as shown in FIG. 2, a galvanometer mirror is used as the horizontal scan section 30 for scanning the light emitted from the light source 20 in the horizontal direction (h), and a polygon mirror is used as the vertical scan section 40 for scanning the light emitted from the light source 20 in the vertical direction (v). Further, the scan rate of the horizontal scan section 30 is lower than the scan rate of the vertical scan section 40, and the horizontal scan section 30 performs low-speed scan while the vertical scan section performs high-speed scan. It should be noted that the scan direction of the present embodiment is different from the scan direction (the high-speed scan is performed in the horizontal direction while the low-speed scan is performed in the vertical direction) of the typical HDTV video signal.

Firstly, as shown in FIG. 4, an image forming area L on the screen 50 is divided into 32 sub-illumination areas L1 through L32 in the low-speed scan direction, namely in the horizontal direction. Further, adjacent ones of the sub-illumination areas L1 through L32 each have an illumination area E. Further, the gain of the screen 50 is 1, and the luminance of the screen is 500 cd/m². It should be noted that these values are illustrative only, and do not limit the meaning or scope of the claimed invention.

As shown in FIG. 2, the horizontal scan section 30 scans the light in the scan direction which is substantially parallel to the horizontal direction. The horizontal scan section 30 is provided with a first galvanometer mirror (a first low-speed scan section) 31 capable of swinging around an axis P1, and a second galvanometer mirror (a second low-speed scan section) 32 capable of swinging around an axis P2.

As shown in FIG. 2, the first galvanometer mirror 31, which is disposed on the left-hand side when facing the screen 50, is assigned to the scan the odd numbered sub-illumination areas from the left end section (one end section) 50b of the screen 50, namely the sub-illumination areas L1, L3, L5, . . . L27, L29, and L31, while the second galvanometer mirror 32, which is disposed on the right-hand side when facing the screen 50, is assigned to the scan the even sub-illumination areas from the left end section (the one end section) 50b of the screen 50, namely the sub-illumination areas L2, L4, L6, . . . L28, L30, and L32. Therefore, the 16 light sources 20 are provided, which correspond with each of the first and second galvanometer mirrors 31, 32. Thus, it is arranged that the 16 light beams enter each of the first and second galvanometer mirrors 31, 32, and the light beams emitted from the 32 light sources 20 can scan the respective sub-illumination areas L1 through L32.

The first galvanometer mirror 31 rotates around the axis P1 to scan the light beams emitted from the light sources 20 in a direction (a first scan direction) from the left end section 50b of the screen 50 towards the right end section 50a thereof.

Further, the second galvanometer mirror 32 rotates around the axis P2 to scan the light beams emitted from the light sources 20 in a direction (a second scan direction) from the right end section 50a of the screen 50 towards the left end section 50b thereof. Further, as shown in FIG. 4, the first and second galvanometer mirror 31, 32 are arranged to have a rotation angle sufficient for scanning each of the light beams from a right end La of each of the sub-illumination areas L1 through L32 to a left end Lb thereof or from the left end Lb to the right end La.

Further, assuming that the projection distance from the first and second galvanometer mirrors 31, 32 to the screen 50 is 800 mm, the beam diameters of the light beams entering the first and second galvanometer mirrors 31, 32 are about φ1.6 mm. It is preferable to use galvanometer mirrors with widths in the horizontal and vertical directions equal to or greater than 3.2 mm as the first and second galvanometer mirrors 31, 32 for making it possible to efficiently acquire the light beams with the present beam diameter.

As shown in FIG. 2, the vertical scan section 40 is provided with a first polygon mirror (a first high-speed scan section) 41 rotatable around an axis Q1, and a second polygon mirror (a second high-speed scan section) 42 rotatable around an axis Q2.

The first and second polygon mirrors 41, 42, each of which has a regular nonagon cross-sectional shape, each have nine side surfaces 41a, 42a, and the light beams reflected by the first and second galvanometer mirrors 31, 32 enter the side surfaces 41a, 42a, respectively.

Further, the first and second polygon mirrors 41, 42 rotate around the axes Q1, Q2 at a constant speed of 30,000 rpm, respectively. It should be noted that in the case in which there are variations in the rotational speeds of the first and second polygon mirrors 41, 42, it is possible to suppress the effect of the variations in the rotational speeds of the first and second polygon mirrors 41, 42 by controlling the operations of the first and second galvanometer mirrors 31, 32, respectively.

The first polygon mirror 41 corresponds to the first galvanometer mirror 31. Further, as shown in FIG. 4, the polygon mirror 41 scans the 16 light beams emitted from the first galvanometer mirror 31 in the vertical direction (v) from the upper end Lc to the lower end Ld of the odd sub-illumination areas L1, L3, L5, . . . L27, L29, and L31 from the left end section 50b of the screen 50.

The second polygon mirror 42 is provided corresponding to the second galvanometer mirror 32, and scans the 16 light beams emitted from the second galvanometer mirror 32 in the vertical direction (v) from the upper end Lc to the lower end Ld of the even sub-illumination areas L2, L4, L6, . . . L28, L30, and L32 from the left end section 50b of the screen 50.

Further, as shown in FIG. 4, the sub-illumination areas L1 through L32 are each composed of 66 vertical scan lines, and in each of the illumination areas E where the adjacent sub-illumination areas L1 through L32 overlap each other, there are 6 overlapping scan lines.

The control section 60 shown in FIG. 1B controls the scan direction of the light beams emitted from the light sources 20 and scanned on the screen 50.

Specifically, as shown in FIG. 5, the control section 60 applies a sawtooth voltage to the first galvanometer mirror 31 to control the mirror 31 with the scan frequency of 60 Hz. Further, as shown in FIG. 5, the control section 60 also applies a sawtooth voltage, which is 180° different in phase from the voltage waveform applied to the first galvanometer mirror 31, to the second galvanometer mirror 32 to control it with the scan frequency of 60 Hz. Further, the first galvanometer mirror 31 and the second galvanometer mirror 32 are synchronized with each other. Thus, as shown in FIG. 2, the first galvanometer mirror 31 rotates counterclockwise around the axis P1 from the initial state illustrated with the solid line to the state illustrated with the broken line. In contrast, the second galvanometer mirror 32 moves clockwise centering around the axis P2 from the initial state illustrated with the solid line to the state illustrated with the broken line. This operation corresponds to one cycle (one frame).

Thus, as shown in FIG. 4, the light beams emitted from the light sources 20 are scanned with the first galvanometer mirror 31 in the odd sub-illumination areas L1, L3, L5, . . . L27, L29, and L31 from the left end Lb to the right end La thereof (in the first scan direction).

At the same time, the light beams emitted from the light sources 20 are scanned with the second galvanometer mirror 32 in the even sub-illumination areas L2, L4, L6, . . . L28, L30, and L32 from the right end La to the left end Lb thereof (in the second scan direction). Therefore, the control section 60 performs the control so that the scan directions of the light beams scanned in the adjacent ones of the sub-illumination areas L1 through L32 are opposite to each other in the screen 50.

Further, the control section 60 controls the pivotal movement of the first and second galvanometer mirrors 31, 32 so that the first and second galvanometer mirrors 31, 32 perform scanning in each frame in sync with each other, and controls the rotation of the first and second polygon mirrors 41, 42 so that the first and second polygon mirrors 41, 42 perform synchronized scanning operations of each scan line. Thus, the scan corresponding to image data in the adjacent sub-illumination areas L1 through L32 can be performed at the same time in both the horizontal and vertical directions.

In the scanning television 1 according to the present embodiment, the horizontal scan directions of the light beams scanned in the adjacent sub-illumination areas L1 through L32 of the screen 50 are opposite to each other on the screen 50. Thus, since the timing difference corresponding to one scan period caused in the scanning in the same direction can be prevented, and it becomes possible to substantially simultaneously scan the overlapping illumination areas E which comprise the seam sections between the adjacent sub-illumination areas L1 through L32.

Therefore, the scanning image display 10 of the present embodiment, which is capable of preventing the display misalignment in the illumination areas, is capable of displaying high-resolution images in high quality, and has a superior moving image display characteristics.

Further, since the first and second polygon mirrors 41, 42 are provided corresponding to the first and second galvanometer mirrors 31, 32, freedom of arrangement of the first and second polygon mirrors 41, 42 increases compared to the case in which the first and second polygon mirrors 41, 42 are disposed integrally as a unit. Thus, it becomes possible to achieve downsizing of the entire device.

Further, by separately providing the first galvanometer mirror 31 for scanning the light beams in the sub-illumination areas L1, L3, . . . L29, and L31 in the direction from the left end Lb to the right end La, and the second galvanometer mirror 32 for scanning the light beams in the sub-illumination areas L2, L4, . . . L30, and L32 in the direction from the right end La to the left end Lb, it becomes easy for the control section 60 to simultaneously scan the illumination areas E as the seam section between the adjacent sub-illumination areas L1 through L32.

Further, by providing the first galvanometer mirror 31 for scanning the odd sub-illumination areas L1, L3, . . . L29, and L31 and the second galvanometer mirror 32 for scanning the even sub-illumination areas L2, L4, L30, and L32, it becomes possible to efficiently scan the light beams emitted from the plurality of light sources 20 in the adjacent sub-illumination areas L1 through L32 in the directions opposite to each other.

Further, since the illumination areas E where adjacent sub-illumination areas L1 through L32 overlap each other are provided, and the scanning process corresponding to the same image data is performed in the overlapping illumination areas E at substantially the same time, a high-quality image can be obtained while preventing the time difference in the scan timing. Further, since the illumination areas E where the adjacent sub-illumination areas overlap each other are provided, the plurality of sub-illumination areas L1 through L32 may be scanned without any gaps. Therefore, even in the case in which the screen 50 is divided into a plurality of sub-illumination areas L1 through L32, a crisp image without any gaps can be displayed on the screen 50. Thus, it becomes possible to perform a superior image display even when the image is moving.

Further, the control section 60 controls the first and second galvanometer mirrors 31, 32 so that the first and second galvanometer mirrors 31, 32 perform scanning in sync with each other in each frame. Thus, since the scan start timing of the first and second galvanometer mirrors 31, 32 can be made the same, it becomes easy to scan the illumination areas E as the seams between the sub-illumination areas at the same time.

### Second Embodiment

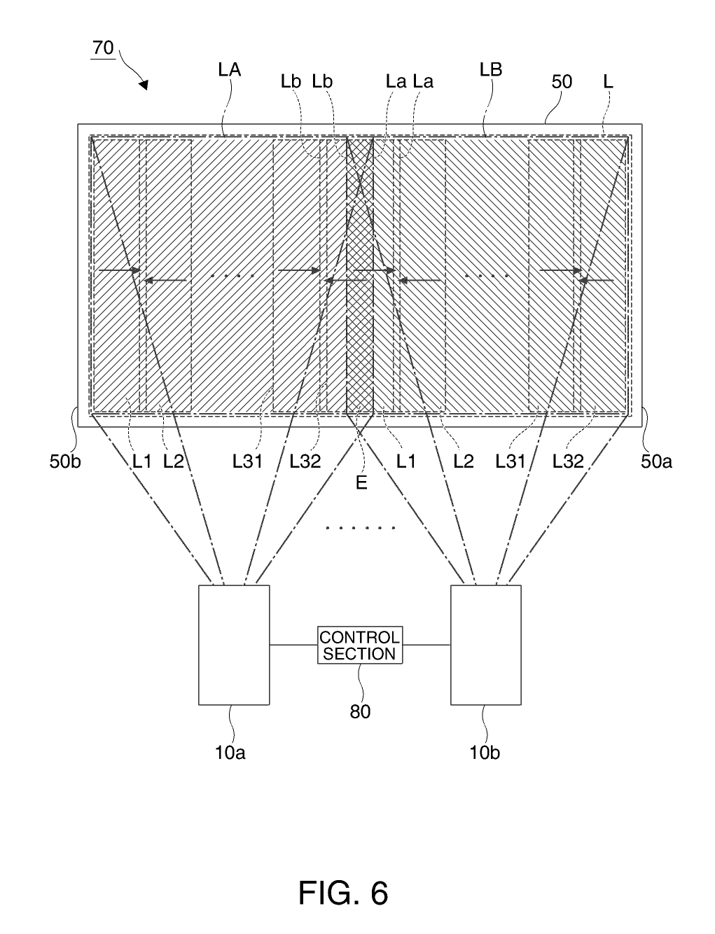

A second embodiment according to the invention will now be explained with reference to FIG. 6. It should be noted that in the drawing of each of the embodiments described hereinafter, portions with configurations common to the scanning television 1 according to the first embodiment described above will be denoted with the same reference numerals, and the explanations thereof will be omitted.

A scanning image display system 70 according to the present embodiment is equipped with two scanning image displays 10a, 10b each substantially the same as the scanning image display 10 shown in FIG. 2 of the first embodiment. The scanning image display system 70 is the same as the scanning television 1 of the first embodiment in the other configurations.

The scanning image display system 70 is provided with two scanning image displays, namely first and second scanning image displays 10a, 10b, housed in a housing (not shown), and displays an image on the screen 50 using the first and second scanning image displays 10a, 10b.

As shown in FIG. 6, in the present embodiment, the image forming area L of the screen 50 is divided into two illumination areas LA and LB in the low-speed scan direction, namely in the horizontal direction. Further, the two adjacent illumination areas LA and LB have the overlapping illumination area E (the central part of the screen 50). It should be noted that the characteristic of the screen 50 is substantially the same as in the first embodiment.

The light beams emitted from the first scanning image display 10a are scanned on the illumination area LA of the screen 50, and the light beams emitted from the second scanning image display 10b are scanned on the illumination area LB of the screen 50. Further, similarly to the image forming area L of the first embodiment, each of the illumination areas LA, LB is divided into 32 sub-illumination areas L1 through L32, and the horizontal scan directions of the adjacent sub-illumination areas L1 through L32 are opposite to each other.

Further, the sub-illumination area L32 of the illumination area LA and the sub-illumination area L1 of the illumination area LB overlap each other to form the illumination area E. Further, the control section 80 controls the first galvanometer mirror 31 shown in FIG. 2 to scan the light beams emitted from the light sources 20 in the sub-illumination area L32 of the illumination area LA from the right end La towards the left end Lb thereof. Further, the control section 80 controls the second galvanometer mirror 32 shown in FIG. 2 to scan the light beams emitted from the light sources 20 in the sub-illumination area L1 of the illumination area LB from the left end Lb towards the right end La thereof.

In other words, the control section 80 performs the control so that the horizontal scan directions in the sub-illumination area L32 of the illumination area LA and the sub-illumination area L1 of the illumination area LB adjacent to each other are opposite to each other in the screen 50.

In the scanning image display system 70 according to the present embodiment, since the scan directions of the light beams scanned on the adjacent illumination areas LA and LB, which are opposite to each other in the screen 50, it is possible to prevent a time difference that is otherwise created when scanning in the same direction. Thus, it becomes possible to substantially simultaneously scan the illumination area E. Therefore, similarly to the case with the first embodiment, since the display misalignment in the seam portion can be prevented, it becomes possible to provide a scanning image display system capable of displaying a high-resolution image in high quality, and superior in the moving image display characteristics.

Further, since the display misalignment in the seam portions can be prevented also between the sub-illumination areas L1 through L32, it is possible to obtain a system with superior moving image characteristics.

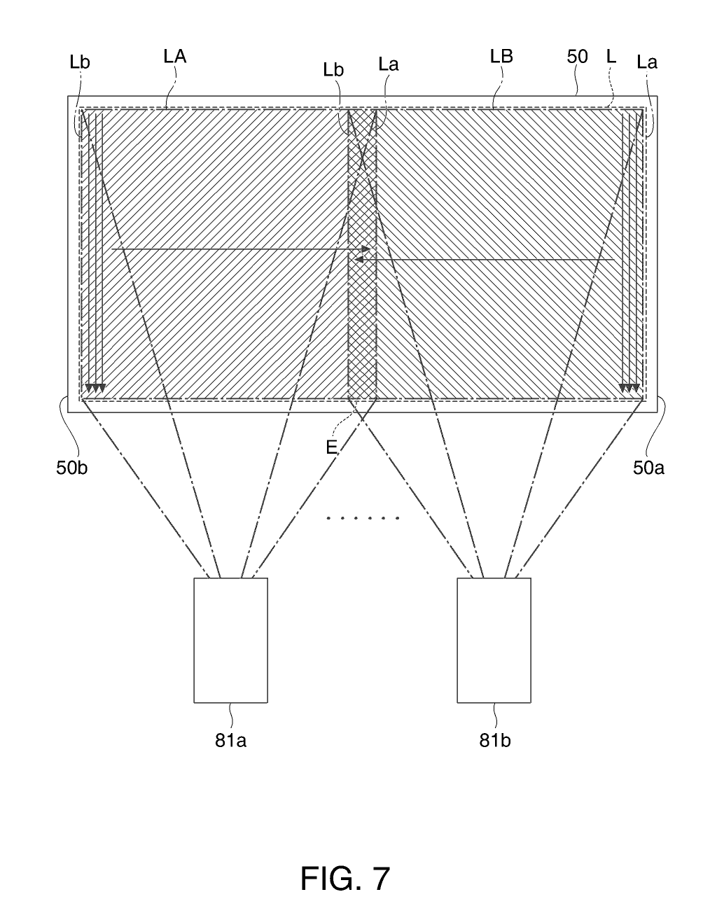

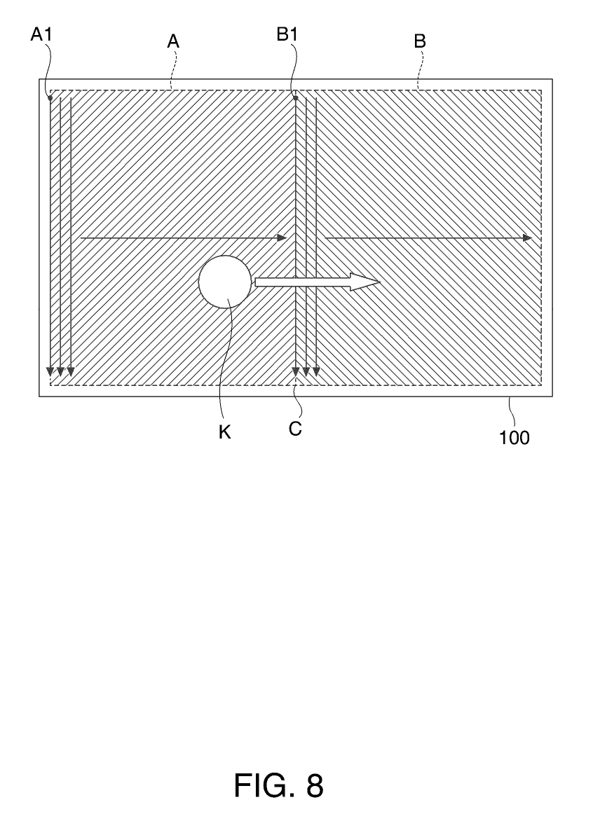

It should be noted that although the image displayed by the first and second scanning image displays 10a and 10b are divided into the sub-illumination areas L1 through L32, it is not necessarily required to thus divide the image. Specifically, as shown in FIG. 7, it is possible to adopt first and second scanning image displays 81a, 81b each provided with a single light source 20, wherein the first scanning image display 81a scans the light beam on the screen 50 from the left end section 50b thereof towards the right end section 50a thereof, and the second scanning image display 81b scans the light beam on the screen 50 from the right end section 50a towards the left end section 50b thereof. In a specific configuration, the light beam emitted from the first scanning image display 81a disposed on the left-hand side when facing the screen 50 scans the illumination area LA from the left end Lb towards the right end La of the illumination area LA. Further, the light beam emitted from the second scanning image display 81b disposed on the right-hand side when facing the screen 50 scans the illumination area LB from the right end La towards the left end Lb. Thus, since the scan directions in the illumination areas LA, LB adjacent to each other are opposite to each other, it becomes possible to obtain the same advantage as in the present embodiment.

Further, although the screen 50 is divided into two illumination areas LA and LB in the horizontal direction, this is not a limitation, and the screen 50 can be divided into three or more illumination areas in the horizontal direction, or divided into two or more columns of illumination areas in the vertical direction.

It should be noted that the scope of the invention is not limited to the embodiments described above, but various modifications can be executed thereon within the scope or the spirit of the invention.

For example, in each of the embodiments described above, it is not necessary for the sub-illumination areas or the illumination areas adjacent to each other to have the overlapping illumination area E, although the invention is not so limited

Further, although the scanning image display described above and the scanning image display system applied to the rear projection scanning television are exemplified for explanations, they can also be applied to a front projection display.

Further, although the screen is divided into 32 areas, the number of divisional areas is not limited thereto.

In addition, although the control section controls the first and second galvanometer mirrors and the first and second polygon mirrors, this is not a limitation.

Still further, although the wavelength converting laser diode is used as the green light source, it is also possible to use another light source for emitting a green laser beam as the green light source, or to use the configuration for converting the infrared light into the light with a predetermined wavelength as both of the red light source and the blue light source similarly to the case with the green light source.

Further, although the configuration of scanning the screen at a low speed in the horizontal direction and at a high speed in the vertical direction is adopted, it is also possible to adopt a configuration of scanning the screen at a high speed in the horizontal direction and at a low speed in the vertical direction. In the case with this configuration, it is possible to divide the screen into a plurality of sub-illumination areas in the vertical direction, in which the scanning is performed at a low speed, and control the first and second galvanometer mirrors so that the scan directions of the light emitted respectively from the first and second galvanometer mirrors are opposite to each other.

Further, although the galvanometer mirrors are used as the first and second low-speed scan sections, and the polygon mirrors are used as the first and second high-speed scan sections, this is not a limitation, but it is possible to adopt any configuration capable of making the scan directions in the adjacent ones of the plurality of sub-illumination areas be opposite to each other.

Further, although the first and second polygon mirrors are provided corresponding to the first and second galvanometer mirrors, it is also possible to use a single polygon mirror. In this configuration, since the number of components can be reduced, alignment of the polygon mirror is simplified.

As described above, the control section needs only to control the pivotal operation of the first and second galvanometer mirrors so that the first and second galvanometer mirrors perform a synchronized scanning process in each frame.

Further, although the light beams emitted from the first and second galvanometer mirrors are scanned on the screen by the first and second polygon mirrors, it is also possible to adopt a configuration of scanning the light beams emitted from the first and second polygon mirrors on the screen by the first and second galvanometer mirrors.

Further, although the first galvanometer mirror is assigned to the odd sub-illumination areas from the left end section of the screen while the second galvanometer mirror is assigned to the even sub-illumination areas from the left end section of the screen, the reverse configuration can also be adopted. Further, it is also possible to provide a plurality of first galvanometer mirrors and a plurality of second galvanometer mirrors respectively assigned to the odd numbered sub-illumination areas and the even numbered sub-illumination areas.

What is claimed is:

1. A scanning image display comprising:
a plurality of light sources capable of emitting a plurality of light beams; and
a scan unit capable of scanning the light beams emitted from the light sources on a projection surface, which comprises a plurality of sub-illumination areas, in a first direction and a second direction which is substantially perpendicular to the first direction, in order to display an image on the projection surface,
wherein one of the first and second direction is a high-speed scan direction in which the light beams are scanned at a higher speed, and the other of the first and second direction comprises a low-speed scan direction in which the light beams of the other of the first and second direction are scanned at a lower speed than the higher speed of the high-speed scan direction, the sub-illumination areas being arranged in the low-speed scan direction, and the low-speed scan direction of one sub-illumination area being opposite to the low-speed scan direction of an adjacent sub-illumination area.

2. The scanning image display according to claim 1,
wherein the scan unit comprises:
a first low-speed scan section capable of scanning at least one of the light beams emitted from at least one of the light sources in a first scan direction which is substantially parallel to the low-speed scan direction;
a second low-speed scan section capable of scanning the remaining of the light beams emitted from the of the light sources in a second scan direction opposite to the first scan direction; and
a high-speed scan section capable of scanning the light beams emitted from the light sources in the high-speed scan direction.

3. The scanning image display according to claim 2, wherein the sub-illumination areas are consecutively numbered from one end section of the projection surface and wherein the first low-speed scan section scans the light beams in the oddly numbered sub-illumination areas, and the second low-speed scan section scans the light beams in the evenly numbered sub-illumination areas.

4. The scanning image display according to claim 2, wherein the high-speed scan section includes a first high-speed scanner provided corresponding to the first low-speed scan section, and a second high-speed scanner provided corresponding to the second low-speed scan section.

5. The scanning image display according to claim 2,
wherein the scan by the first low-speed scan section and the scan by the second low-speed scan section are synchronized.

6. The scanning image display according to claim 1,
wherein the projection surface includes at least one overlapping area where adjacent sub-illumination areas overlap each other.

7. A scanning image display system comprising:
a plurality of scanning image displays, each scanning image comprising:
at least one light source adapted to emit at least one light beam;
a scan unit adapted to scan the light beams emitted from the at least one light source on a projection surface, which comprises a plurality of sub-illumination areas, in a first direction and a second direction substantially perpendicular to the first direction, so as to display an image,
wherein one of the first and second direction is a high-speed scan direction in which the light beams are scanned at a higher speed, and the other of the first and second direction comprises a low-speed scan direction in which the light beams of the other of the first and second direction are scanned at a lower speed than the higher speed of the high-speed scan direction, the illumination areas being arranged in the low-speed scan direction, and the low-speed scan direction in one illumination area being opposite than the low-speed scan direction of an adjacent illumination area.

8. The scanning image display system according to claim 7, wherein the illumination areas of the projection surface each comprise a plurality of sub-illumination areas in the low-speed scan direction, and the low-speed scan direction one of the light beams scanned in one of the sub-illumination areas being opposite to the low-speed scan direction of at least one of the light beams scanned in an adjacent sub-illumination area.

9. A scanning image display comprising:
a plurality of light sources capable of emitting a plurality of light beams; and
a scan unit capable of scanning the light beams emitted from the light sources on a projection surface, which comprises a plurality of sub-illumination areas, in order to display an image on the projection surface, the scan unit comprising:
a first low-speed scan section capable of scanning at least one of the light beams emitted from at least one of the light sources in a low-speed scan direction;
a second low-speed scan section capable of scanning the remaining of the light beams emitted from the of the light sources in a second scan direction opposite to the first scan direction; and
a high-speed scan section capable of scanning the light beams emitted from the light sources in a high-speed scan direction, which is substantially perpendicular to the low-speed scan direction;
wherein the light beams are scanned at a higher speed in the high-speed scan direction than in the low-speed scan direction, and wherein the sub-illumination areas are arranged in the low-speed scan direction such that adjacent sub-illumination areas are scanned using alternating first and second low-speed scan sections, such that the light beams emitted from adjacent sub-illumination areas are scanned in opposite directions.

10. The scanning image display according to claim 9, wherein the sub-illumination areas are consecutively numbered from one end section of the projection surface and wherein the first low-speed scan section scans the light beams in the oddly numbered sub-illumination areas, and the second low-speed scan section scans the light beams in the evenly numbered sub-illumination areas.

11. The scanning image display according to claim 9, wherein the high-speed scan section includes a first high-speed scanner provided corresponding to the first low-speed scan section, and a second high-speed scanner provided corresponding to the second low-speed scan section.

12. The scanning image display according to claim 9,
wherein the scan by the first low-speed scan section and the scan by the second low-speed scan section are synchronized.

13. The scanning image display according to claim 9,
wherein the projection surface includes at least one overlapping area where adjacent sub-illumination areas overlap each other.
